(19) United States
(12) Patent Application Publication
(10) Pub. No.: US 2012/0075681 A1
(43) Pub. Date: Mar. 29, 2012

(54) IMAGE FORMING APPARATUS

(75) Inventor: Hiroshige Inoue, Tokyo (JP)

(73) Assignee: CANON KABUSHIKI KAISHA, Tokyo (JP)

(21) Appl. No.: 13/226,652

(22) Filed: Sep. 7, 2011

(30) Foreign Application Priority Data
Sep. 27, 2010 (JP) 2010-215927

(51) Int. Cl. H04N 1/04

(52) U.S. Cl. 358/498

(57) ABSTRACT

The present invention provides an image forming apparatus which can increase the life of a fixing roller without causing increase of the apparatus in size and image displacement. A first skew feeding and registration correcting portion 1 and a second skew feeding and registration correcting portion are controlled so as to move the sheet in a first direction in a width direction in correcting a side end position of a sheet by the first skew feeding and registration correcting portion and to move the sheet in stages in a second direction in the width direction which is opposite to the first direction in the width direction in correcting the side end position of the sheet by the second skew feeding and registration correcting portion.

### BACKGROUND OF THE INVENTION

1. Field of the Invention

The present invention relates to an image forming apparatus and particularly to a structure for correcting displacement of a sheet in a width direction when two image forming portions are provided along a sheet conveying direction and the respective image forming portions form images on the sheet.

2. Description of the Related Art

Conventionally, in an image forming apparatus such as a copying machine, a printer, and a facsimile, an image forming portion includes a sheet conveying apparatus for conveying a sheet such as recording paper. In some cases, the sheet conveying apparatus includes a skew feeding correcting portion for correcting skew feeding of the sheet in order to correct an attitude and a position of the sheet before the sheet is conveyed to the image forming portion.

In recent years, various kinds of sheets such as coated paper, embossed paper, super thick paper, and super thin paper are used in the image forming apparatus. Therefore, not only increase in productivity but also increase in speed and precision of skew feeding correction are required of the image forming apparatus so that the apparatus can handle any kind of sheet to be used. For this purpose, US Pub. No. 2009/0295075A1 proposes a skew feeding correcting portion which includes two pairs of skew feeding correcting rollers disposed at a predetermined interval in a width direction and corrects skew feeding with the pairs of skew feeding correcting rollers while conveying the sheet without temporarily stopping it in order to increase speed and precision of the skew feeding correction.

Although the skew feeding correcting portion formed as described above can correct positions of any kind of sheet at high speed and with high precision, sheets are conveyed repeatedly at high speed to the same position downstream from the skew feeding correcting portion. For example, the sheets onto which a toner image formed on a photosensitive drum has been transferred are conveyed to the same position of a fixing roller of a fixing portion for fixing the toner image onto the sheet. A surface layer of the fixing roller is made up of a rubber portion and soft in order to handle sheets like the embossed paper. Therefore, especially when high-rigidity sheets with large burrs which have never been experienced before are passed continuously for a long time, it damages the rubber portion forming the surface layer portion of the fixing roller to considerably shorten life.

Therefore, conventionally, the image to be formed on the photosensitive drum is displaced by a predetermined amount and a sheet correcting position in the width direction by pairs of registration rollers is displaced by a predetermined amount to convey the sheet, for example. In this way, it is possible to prevent damage to the roller surface layer due to conveyance of the sheets to the same position of the fixing roller. In this case, it is preferable to set a sufficiently large displacement amount of the sheet correcting position in order to satisfactorily increase the life of the roller surface layer.

However, if the displacement amount of the sheet correcting position is sufficiently large in the image forming apparatus having such a related-art skew correcting portion, the pairs of registration rollers need to be slid to both front and back sides of the apparatus according to a sheet detected position. Here, as a skew feeding correcting portion for sliding the pairs of registration rollers to both the front and back sides, there is one having a slide drive portion 55 for sliding the pair of registration rollers 30 by using a belt 57 as illustrated in FIG. 9, for example.

With this slide drive portion 55, however, driving backlash causes a wide range of variation in lateral registration correcting precision of the sheets. The driving backlash is backlash of the slide drive portion 55 and is caused by a difference in deflection between a tense side and a slack side of the belt 57. If the driving backlash occurs, a sliding amount of the sheet becomes insufficient and the variation in the lateral registration correcting precision of the sheets becomes wider. For example, if sliding directions of an N−1th sheet and an Nth sheet S are different as illustrated in FIG. 10A, a relationship between a difference DS, between a sheet side end position detected by a sheet position detecting portion (not illustrated) and an apparatus center 500, and a sliding amount D1 of the slide drive portion 55 is DS=D1.

On the other hand, if the sheet sliding directions of the N−1th sheet and the Nth sheet are the same, a drive gear 58 for driving the belt 57 illustrated in FIG. 9 rotates in an opposite direction to an arrow to slide the Nth sheet. Here, when the drive gear 58 rotates in this direction, it rotates toward a deflection direction of the belt 57 and therefore cannot transmit driving to a registration slide unit for a very short time till when a belt deflection side moves to the tense side.

In this case, a sliding insufficiency amount Δ of the slide drive portion 55 is caused and the relationship between the DS and a sliding amount D2 of the slide drive portion 55 is DS=D2−Δ as illustrated in FIG. 10B. In this manner, if the sliding directions of the N−1th sheet and the Nth sheet are the same, the sliding insufficiency amount Δ is caused.

Here, if the sliding insufficiency amount Δ is caused, a position displacement amount of the sheet S in the image forming apparatus from the center of the apparatus is different between the case in which the sliding directions of the N−1th sheet and the Nth sheet are different and the case in which they are the same. For example, a left-right margin α when the sliding directions of the N−1th sheet and the Nth sheet are different in FIG. 11A and a left-right margin β when the sliding directions of the sheets are the same in FIG. 11B are different. In this manner, the left-right margin is different between the case in which the sliding directions of the N−1th sheet and the Nth sheet are different and the case in which the sliding directions of the sheets are the same, which causes image displacement.

There is a related-art image forming apparatus including two image forming portions arranged along a sheet conveying direction. To form images on both sides of a sheet, after the image is formed on the first side of the sheet in one of the image forming portion, the sheet is reversed and conveyed to the other image forming portion and then the image is formed on the second side in the other image forming portion.

Here, in such an image forming apparatus, if the sheet is displaced widely to a back side, for example, in forming the image on the first side of the sheet, the sheet is conveyed to the other image forming portion in the state in which it is displaced widely to the back side in forming the image on the second side. Here, if the sheet is displaced to the back side before it reaches the other image forming apparatus, the sheet which has already been displaced widely to the back side is displaced further to the back side. In this case, a depth of the slide drive portion positioned upstream from the other image forming portion increases, which increases the image forming apparatus in size. In this manner, if the displacement amount of the sheet correcting position is sufficiently large, it is possible to satisfactorily increase the life of the roller surface layer, though the apparatus increases in size or the image displacement occurs depending on the sliding directions of the sheets.

Therefore, the invention has been made with such circumstances in view and provides an image forming apparatus for increasing life of a fixing roller without causing increase of the apparatus in size and image displacement.

### SUMMARY OF THE INVENTION

An image forming apparatus including a first image forming portion which forms an image on a sheet and a second image forming portion which is provided on a downstream of the first image forming portion in a sheet conveying direction includes: a first correcting portion which is provided on an upstream of the first image forming portion in the sheet conveying direction, successively moves the sheet, which has been conveyed to the first image forming portion, from a standard position to a predetermined position in stages in a width direction orthogonal to the sheet conveying direction, and moves the sheet, which has reached the predetermined position, from the standard position to the predetermined position again in stages to correct a side end position of the sheet in the width direction; a second correcting portion which is provided between the first image forming portion and the second image forming portion, successively moves the sheet, on which an image has been formed by the first image forming portion, from a standard position to a predetermined position in stages in the width direction, and moves the sheet, which has reached the predetermined position, from the standard position to the predetermined position again in stages to correct the side end position of the sheet in the width direction; and a controlling portion which controls the first correcting portion and the second correcting portion, wherein the controlling portion controls the first correcting portion and the second correcting portion so as to move the sheet in stages in one direction in the width direction in correcting the side end position of the sheet by the first correcting portion and to move the sheet in stages in an opposite direction to the moving direction of the sheet by the first correcting portion in correcting the side end position of the sheet by the second correcting portion.

By moving the sheet in the opposite direction, in correcting the side end position of the sheet by the second correcting portion, to the direction in correcting the side end position of the sheet by the first correcting portion, it is possible to increase life of a fixing roller without causing increase of the apparatus in size and image displacement.

Further features of the present invention will become apparent from the following description of exemplary embodiments with reference to the attached drawings.

### BRIEF DESCRIPTION OF THE DRAWINGS

FIG. 1 is a schematic block diagram of a printer which is an example of an image forming apparatus according to an embodiment of the present invention;

FIG. 2 is a drawing for describing a structure of a skew feeding and registration correcting portion provided to a sheet conveying apparatus of the printer;

FIG. 3 is a drawing for describing skew feeding and registration correction control operation of the skew feeding correcting portion;

FIG. 4 is a control block diagram of the printer;

FIG. 5 is a flowchart for describing the skew feeding and registration correction control operation of the skew feeding correcting portion;

FIG. 6 is a first drawing for describing an outline of reciprocating operation of the skew feeding correcting portion;

FIGS. 7A and 7B are second drawings for describing the outline of the reciprocating operation of the skew feeding correcting portion;

FIGS. 8A and 8B are third drawings for describing the outline of the reciprocating operation of the skew feeding correcting portion;

FIG. 9 is a schematic explanatory view of a related-art lateral registration correcting portion;

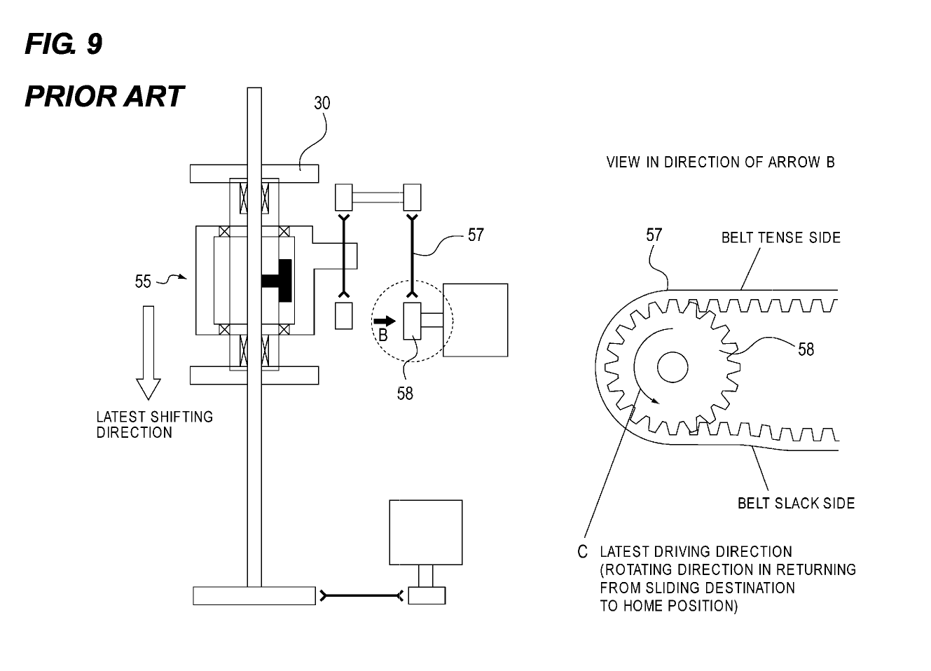

FIG. 10 is a drawing for describing registration correcting operation of the related-art lateral registration correcting portion; and

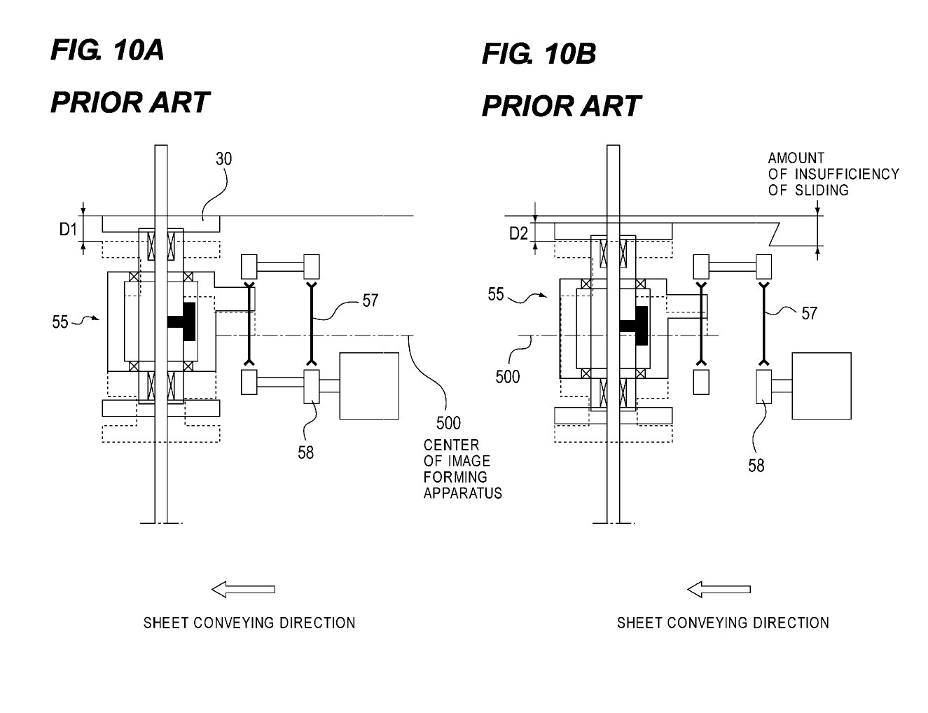

FIGS. 11A and 11B are drawings illustrating related-art resultant sheets.

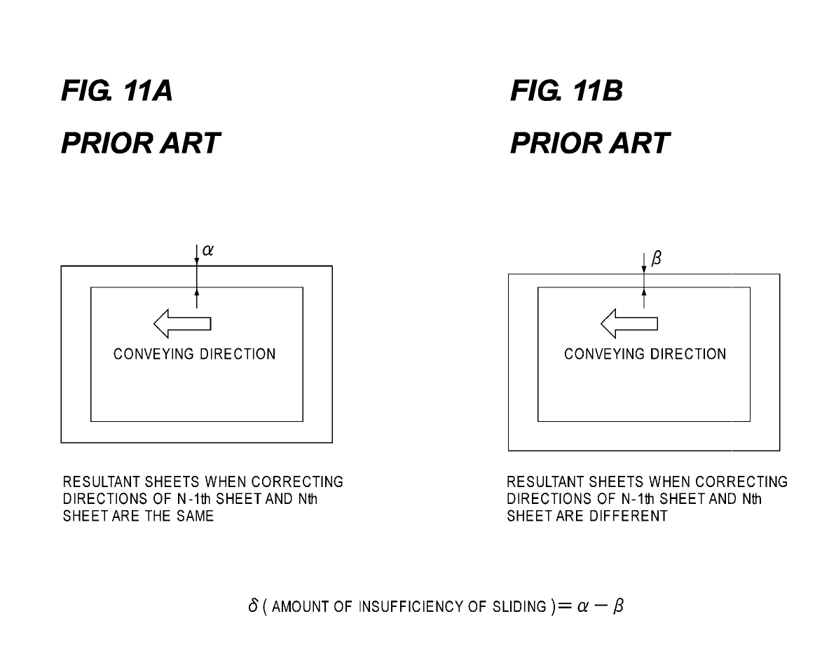

### DESCRIPTION OF THE EMBODIMENTS

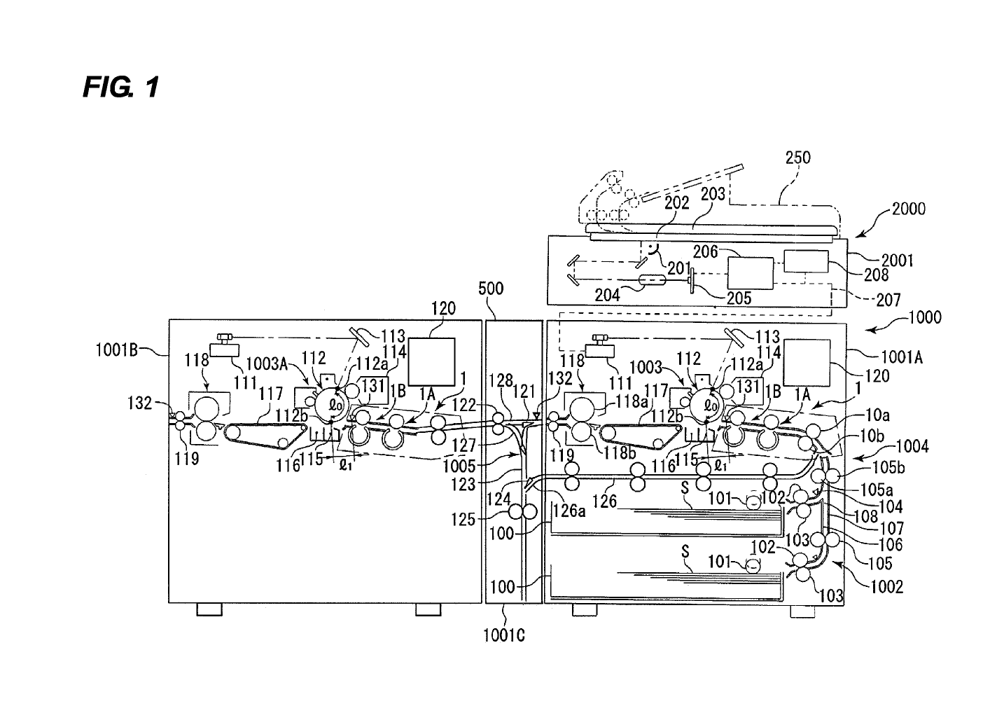

A mode for carrying out the present invention will be described below in detail by using the drawings. FIG. 1 is a schematic block diagram of a printer which is an example of an image forming apparatus according to an embodiment of the present invention.

In FIG. 1, a printer 1000 includes a first printer main body 1001A, a second printer main body 1001B, and a sheet reversing portion 1001C provided between the first printer main body 1001A and the second printer main body 1001B.

The first printer main body 1001A has, on its upper face, a scanner 2000 for reading a document. Here, the scanner 2000 includes a scanning optical system light source 201, a platen glass 202, and a document pressure plate 203 which can be opened and closed. Moreover, the scanner 2000 includes an image reading portion 2001 having a lens 204, a light receiving element (photoelectric conversion element) 205, an image processing portion 206, a memory portion 208 for storing image processing signals processed in the image processing portion 206, and the like.

To read the document, the scanning optical system light source 201 irradiates the document (not illustrated) placed on the platen glass 202 with light. Then, after the read document image is processed by the image processing portion 206, it is converted to an electric signal 207 by electrical encoding and transmitted to a laser scanner 111 which is an image forming portion. Alternatively, the image information processed in the image processing portion 206 and encoded may be stored temporarily in the memory portion 208 and transmitted to the laser scanner 111 as necessary in response to a signal from a controller 120.

The first printer main body 1001A includes a sheet feeding apparatus 1002 and a sheet conveying apparatus 1004 for conveying a sheet S fed by the sheet feeding apparatus 1002 to an image forming portion (first image forming portion) 1003. The first printer main body 1001A also includes the controller 120 which is a controlling portion for controlling the printer 1000.

The sheet feeding apparatus 1002 includes two (a plurality of) sheet cassettes 100, pickup rollers 101, and separating portions each having a feed roller 102 and a retard roller 103. The sheets S in the sheet cassette 100 are separated and fed one by one by the action of the pickup roller 101 which lifts and lowers/rotates at a predetermined time and the separating portion. The sheet conveying apparatus 1004 includes pairs of vertical path rollers 105 (105a, 105b) and a pair of assist rollers 10 (10a, 10b). The sheet conveying apparatus 1004 is provided on an upstream of the image forming portion 1003 in a sheet conveying direction and includes a first skew feeding and registration correcting portion 1 which is a first correcting portion having a skew feeding correcting portion 1A and a registration correcting portion 1B (described later).

Then, the sheet S fed from the sheet feeding apparatus 1002 is passed by the pairs of vertical path rollers 105 through a sheet conveying passage 108 made up of guide plates 106 and 107 curved at their upper portions and led to the first skew feeding and registration correcting portion 1. Then, after displacement in the width direction orthogonal to the skew feeding and sheet carrying direction is corrected in the first skew feeding and registration correcting portion 1 as described later, the sheet S is conveyed to the image forming portion 1003.

The image forming portion 1003 is of an electrophotographic system and includes a photosensitive drum 112 which is an image bearing member, the laser scanner 111 which is an image writing portion, a development device 114, a transfer charger 115, a separating charger 116, and the like. In image forming, first, a laser light from the laser scanner 111 and corresponding to document image information is folded back by a mirror 113 and irradiated to an exposure position 112a on the photosensitive drum rotating clockwise to thereby form a latent image on the photosensitive drum. The latent image formed on the photosensitive drum in this manner is developed into a toner image by the development device 114.

The second printer main body 1001B forms an image on the sheet which has passed through the sheet reversing portion 1001C after the image is formed on the sheet by the first printer main body 1001A.

The second printer main body 1001B includes an image forming portion (second image forming portion) 1003A provided on the downstream of the image forming portion 1003 in the sheet conveying direction and having a similar structure to the image forming portion 1003. The second printer main body 1001B includes a second skew feeding and registration correcting portion 1′ which is a second correcting portion provided between the image forming portion 1003A and the image forming portion 1003 of the first printer main body 1001A, a controller 120, and the like. On a side portion of the second printer main body 1001B, a sheet processing apparatus (not illustrated) for processing the sheets S discharged from the second printer main body 1001B may be provided.

The sheet reversing portion 1001C includes a reversing path 123 for reversing the sheet and conveying it to the image forming portion 1003 of the first printer main body 1001A again and reversing rollers 125 provided to the reversing path 123. The sheet reversing portion 1001C includes a first guide path 126a for conveying the sheet reversed by the reversing rollers 125 to a duplex path 126 provided in the first printer main body. Furthermore, the sheet reversing portion 1001C includes a second guide path 127 for conveying the reversed sheet in the reversed state to the second printer main body 1001B, a discharge switch member 121, and the like.

In FIG. 1, a registration sensor 131 provided downstream from a registration correcting portion 1B senses the sheet S which passes through the registration correcting portion 1B. In the first printer main body 1001A, if the registration sensor 131 senses the sheet S which passes through the registration correcting portion 1B, based on a sensing signal, the controller 120 sends a sheet tip end signal (image tip signal) to the laser scanner 111 after T seconds, for example, as described later. In this way, the laser scanner 111 starts the irradiation with the laser light.

The toner image on the photosensitive drum and developed in this manner is then transferred to the sheet S by the transfer charger 115 in a transfer portion 112b. A distance from the laser light irradiation position 112a of the photosensitive drum 112 to the transfer portion 112b is 10. The sheet S to which the toner image is transferred in this manner is electrostatically separated from the photosensitive drum 112 by the separating charger 116 and then conveyed to a fixing apparatus 118 by a conveying belt 117. Then, after pressurized and heated by a fixing roller 118a and a pressure roller 118b in the fixing apparatus 118, the transferred image is fixed permanently. Then, the sheet S on which the image is fixed is discharged into the second printer main body 1001B by conveying rollers 119 and discharge rollers 122 provided to a discharge path 128.

To form images on both sides of the sheet, by switching the discharge switch member 121 provided between the conveying rollers 119 and the discharge rollers 122, the sheet S on one side of which the image is formed (fixed) is conveyed to the reversing path 123. Then, the sheet S conveyed to the reversing path 123 is reversed by the reversing rollers 125, passed through the first guide path 126a and the duplex path 126, and conveyed to the image forming portion 1003 again and the image is formed on the back side of the sheet S without the image. Then, the sheet S with images formed on both the front and back sides thereof is then discharged into the second printer main body 1001B by the discharge rollers 122. The sheet discharged from the first printer main body 1001A is sensed by a discharge sensor 132.

To reverse the sheet and discharge it into the second printer main body 1001B, the sheet S conveyed to the reversing path 123 is reversed by the reversing rollers 125 and discharged into the second printer main body 1001B through the second guide path 127. When the sheet with the image formed on itself is conveyed to the second printer main body 1001B, the second printer main body 1001B forms the image on the sheet in the image forming portion 1003A and then discharges the sheet to a sheet stack tray or the sheet processing apparatus (not illustrated).

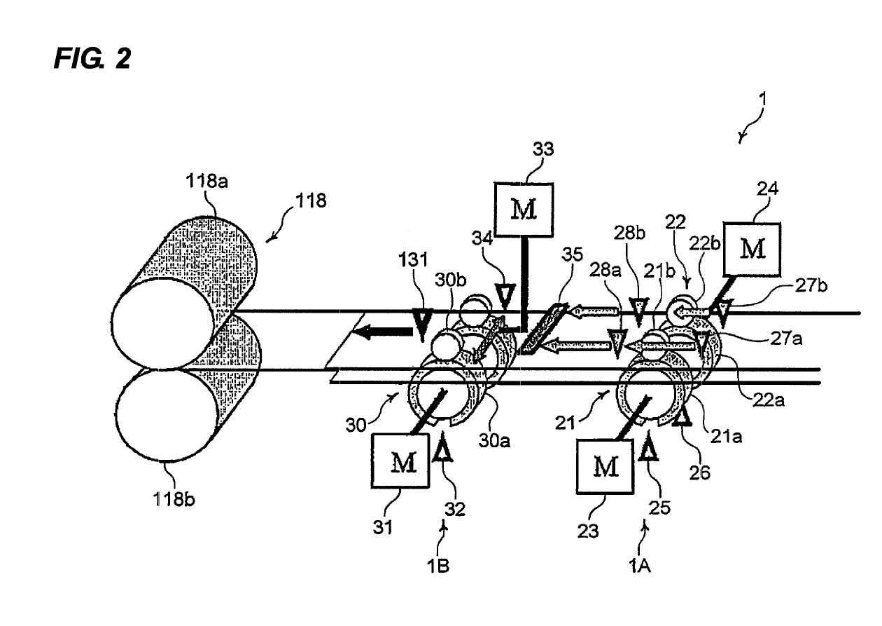

In forming the image in the first and second printer main bodies 1001A and 1001B, the first skew feeding and registration correcting portion 1 carries out screw feeding and registration correction of the sheet. Next, the first skew feeding and registration correcting portion 1 will be described. The first skew feeding and registration correcting portion 1 includes the skew feeding correcting portion 1A for correcting the skew feeding of the sheet and the registration correcting portion 1B for correcting the displacement of the sheet in the width direction as illustrated in FIG. 2.

Here, the skew feeding correcting portion 1A includes two skew feeding correcting rollers 21, 22 disposed at a predetermined interval in the width direction. The pair of skew feeding correcting rollers 21, 22 includes drive rollers 21a, 22a which are drive rotating members respectively having notch portions on their peripheral faces and follower rollers 21b, 22b which are follower rotating members pressed against the drive rollers 21a, 22a by pressure springs (not illustrated). The drive rollers 21a, 22a are disposed at a predetermined direction in the width direction orthogonal to the sheet conveying direction and skew feeding correcting motors 23, 24 are connected to the drive rollers 21a, 22a to drive them separately. In FIG. 2, skew feeding correcting HP sensors 25, 26 sense HPs (home positions) of the drive rollers 21a, 22a.

On the upstream of the pair of skew feeding correcting rollers 21, 22 in the sheet conveying direction, startup sensors 27a, 27b which are tip end sensor portions for detecting a tip end of the sheet and sensing skew feeding of the sheet tip end are disposed at a predetermined interval in the width direction. Then, by calculating a skew feeding amount according to times at which the startup sensors 27a, 27b sense the sheet tip end and starting driving of the skew feeding correcting motors 23, 24, it is possible to correct the skew feeding of the sheet.

On the downstream of the pair of skew feeding correcting rollers 21, 22 in the sheet conveying direction, skew feeding sensors 28a, 28b for sensing if the skew feeding has been corrected completely by the pair of skew feeding correcting rollers 21, 22 are disposed at a predetermined interval in the width direction. If the skew feeding sensors 28a, 28b sense the skew feeding of the sheet tip end, the pair of skew feeding correcting rollers 21, 22 corrects the skew feeding again. Center lines connecting the startup sensors 27a, 27b and the skew feeding sensors 28a, 28b are parallel to an axis of the photosensitive drum 112 disposed on the downstream in the conveying direction. Here, in the embodiment, the skew feeding of the sheet is corrected by preceding side deceleration control for decelerating a preceding side of the sheet tip end.

The registration correcting portion 1B includes two pairs of registration rollers 30 each having a registration drive roller 30a which is a drive rotating member having a notch portion on its peripheral face and a registration follower roller 30b pressed against the registration drive roller 30a by a pressure spring (not illustrated). The registration drive roller 30a is connected to a registration motor 31. The registration drive roller 30a can slide in the axial direction and is slid in the width direction by a registration shift motor 33.

On the upstream of the pairs of registration rollers 30 in the sheet conveying direction, a lateral registration sensor 35 which is a side end position sensor portion continuously senses a position of a sheet side end of the conveyed sheet parallel to the sheet conveying direction and senses a position displacement amount of the sheet side end in the width direction. In the embodiment, the lateral registration sensor 35 includes a line sensor and senses a change in a lateral registration position which is a position of the sheet side end in the width direction to calculate a skew feeding amount of the sheet in the conveying direction as described later.

Then, the registration shift motor 33 is driven according to the lateral registration position (side end position) sensed by the lateral registration sensor 35 to slide the pairs of registration rollers 30 in the axial direction to thereby correct the side end position of the sheet. In other words, in the embodiment, the pairs of registration rollers 30 which are the side end correcting portions move the sheet in the width direction while conveying the sheet according to the side end position detected by the lateral registration sensor 35 to thereby correct the side end position of the sheet.

On the downstream of the pairs of registration rollers 30, a registration sensor 131 for sensing the tip end of the sheet is disposed. A registration HP sensor 32 senses an HP (home position) of the registration drive roller 30a and a registration shift HP sensor 34 senses an HP (home position) of the pairs of registration rollers 30 in the width direction.

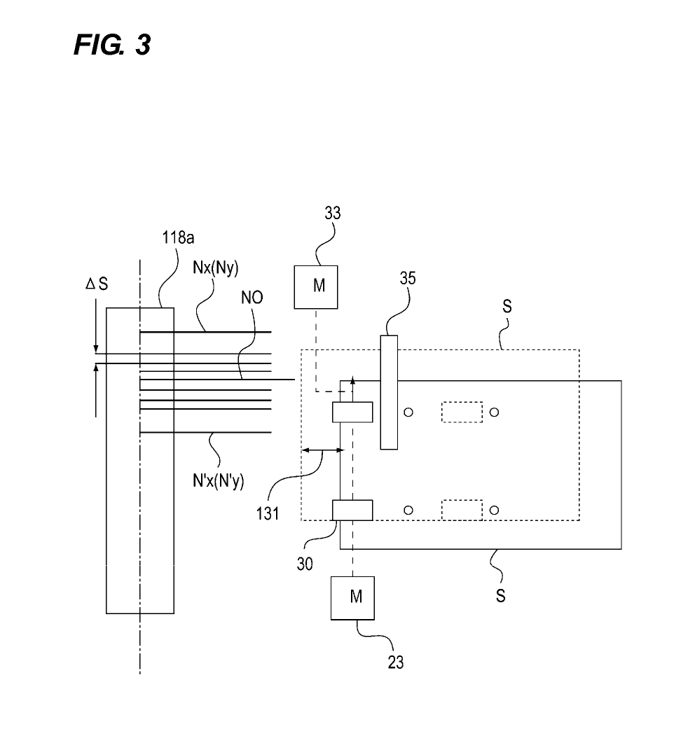

In the embodiment, in shifting the sheet in the width direction, the shifted sheet passes through a predetermined position out of preset shift positions (Nx to N′x, Ny to N′y) of the fixing roller 118a illustrated in FIG. 3. In this way, it is possible to increase life of the fixing roller 118a. In order to enable the shift of the sheet, the exposure position on the photosensitive drum is displaced to shift the sheet in advance in the width direction.

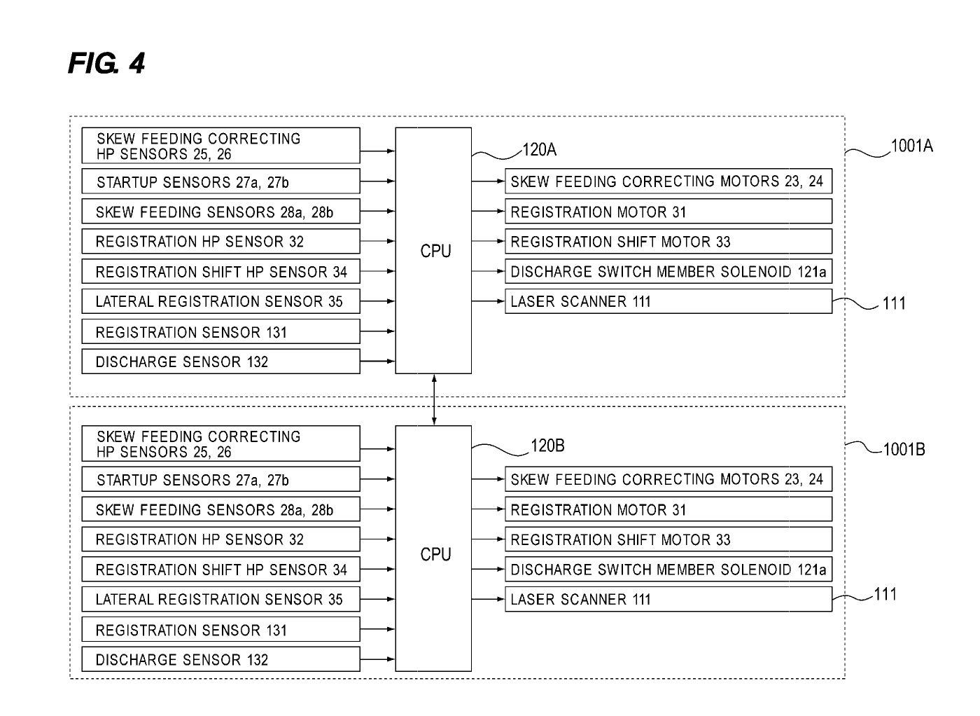

FIG. 4 is a control block diagram of the printer 1000. Sensing signals from the above-described skew feeding correcting HP sensors 25, 26 and the above-described startup sensors 27a, 27b are respectively input to CPUs 120A, 120B provided to the respective controllers 120 (see FIG. 1) of the first and second printer main bodies 1001A, 1001B. To the CPUs 120A, 120B which are the controlling portions, sensing signals from the skew feeding sensors 28a, 28b, the registration HP sensors 32, the registration shift HP sensors 34, the lateral registration sensors 35, the registration sensors 131, and the discharge sensors 132 are input, respectively.

On the other hand, to the CPUs 120A, 120B, the skew feeding correcting motors 23, 24, the registration motors 31, the registration shift motors 33, a discharge switch member solenoids 121a, and the laser scanners 111 are connected, respectively. An operation portion (not illustrated) is connected to the CPU 120A. The CPU 120A drives the respective motors based on the detection signals from the respective sensors and a copying or printing start signal from the operation portion. The CPU 120B of the second printer main body 1001B is connected to the CPU 120A of the first printer main body 1001A and drives the respective motors based on the sensing signals from the respective sensors and the copying or printing start signal from the operation portion transmitted via the CPU 120A.

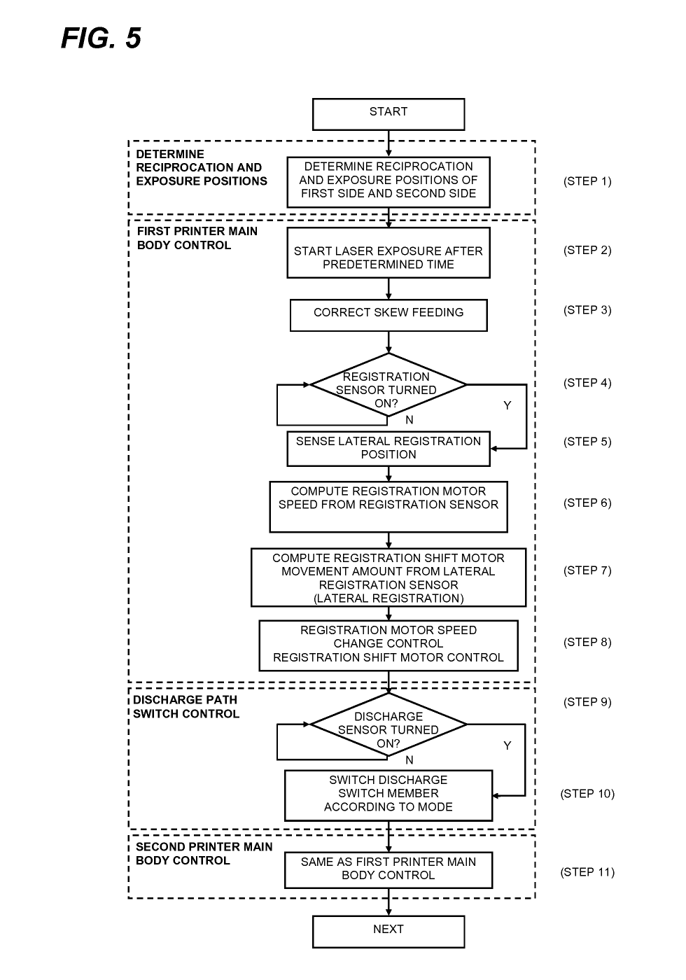

By the CPUs 120A, 120B (controllers 120), skew feeding correcting operation and registration correction control operation according to a duplex mode illustrated in a flowchart in FIG. 5 are carried out. In other words, if copying or printing is started, first side reciprocation position in the first printer main body 1001A and a first side reciprocation position in the second printer main body 1001B by the CPU 120A and 120B are determined according to the duplex mode set by the operation portion (Step 1). Then, after predetermined time since the end of such reciprocation and exposure position determining processing, laser exposure is started according to the reciprocation position determined in the first printer main body 1001A (Step 2).

Next, if the startup sensors 27a, 27b detect the tip end of the sheet S conveyed to the skew feeding correcting portion 1A, the skew feeding correcting motors 23, 24 are respectively started at the times of detection by the startup sensors 27a, 27b. From a time lag between detection times by the startup sensors 27a, 27b, a skew feeding amount of the sheet tip end is calculated and a correction amount is computed. Then, based on the computed correction amount, the pair of skew feeding correcting rollers 21, 22 roller nip portions of which have been open is rotated under the above-described preceding side deceleration control and the skew feeding is carried out (Step 3). If the skew feeding is not corrected completely, a skew feeding amount of the sheet S is detected by the downstream skew feeding sensors 28a, 28b and second skew feeding correction is carried out.

Next, the registration motor 31 is started upon sensing by a delayed side of the downstream skew feeding sensors 28a, 28b, the pairs of registration rollers 30 roller nip portions of which have been open rotate, and the sheet S is conveyed. If the sheet S is nipped by the pairs of registration rollers 30, the skew feeding correcting motors 23 and 24 stop with the roller nip portions of the pairs of skew feeding correcting rollers 21, 22 open upon sensing by the skew feeding correcting HP sensors 25, 26, respectively.

Next, after this control processing, turning on of the registration sensor 131 upon sensing of the sheet is waited for (Step 4). If the registration sensor 131 senses the sheet and is turned on (Y in step 4), the lateral registration sensor 35 senses the side end position (lateral registration position) of the sheet S (Step 5). Next, after this lateral registration sensing processing, the tip end position (tip registration) of the sheet is computed from the signal from the registration sensor 131 and computation of a speed of the registration motor 31 is carried out so that the tip end of the sheet is positioned in the predetermined position (Step 6). According to the lateral registration amount (sheet side end position information) sensed by the lateral registration sensor 35, a movement amount by the registration shift motor 33 is computed (Step 7).

Next, speed change control of the registration motor 31 is carried out based on a time lag between a sensing time by the registration sensor 131 and a time at which the photosensitive drum 112 is irradiated with the laser light to align an image position on the photosensitive drum and the tip end position of the sheet S with each other. Based on the sensing signal from the lateral registration sensor 35 and the determined reciprocation position, the registration shift motor 33 is controlled to align the image position on the photosensitive drum 112 and the lateral registration position of the sheet S with each other.

Next, after these registration motor speed change control and registration shift motor control (Step 8), the sheet S the position of which has been aligned with the image on the drum 112 with high precision is corrected to the fixing apparatus 118. Then, the sheet S conveyed by the pairs of registration rollers 30 is transferred and attracted to the photosensitive drum 112 and the registration motor 31 stops with the roller nip portions of the pairs of registration rollers 30 open upon sensing by the registration HP sensor 26. At the same time, the registration shift motor 33 is started to shift the sheet S in an opposite direction to that in Step 8 and stops upon sensing by the registration shift HP sensor 34.

Next, whether the discharge sensor 132 is turned on is determined (Step 9). If the discharge sensor 132 is turned on (Y in Step 9), the discharge switch member solenoid 121a is actuated selectively based on a set mode to switch the discharge switch member 121 (Step 10). For example, in the case of the duplex mode, the discharge switch member solenoid 121a is actuated and the discharge switch member 121 is switched to convey the sheet to the reversing path 123. Then, after the images are formed on the both sides of the sheet, the sheet S is discharged into the second printer main body 1001B.

In a case of a single-side mode, the sheet is discharged to the sheet processing apparatus (not illustrated) by the conveying rollers 119 and the discharge rollers 122. In a case of the reverse mode in which the sheet is reversed and discharged, after the discharge switch member 121 is switched to convey the sheet into the reversing path 123, the sheet is reversed by the reversing rollers 125 and discharged into the second printer main body 1001B through a second guide path 126b.

Then, after the discharge path switch control, the CPU 120B of the second printer main body 1001B carried out the same control as that for the first printer main body 1001A. In other words, if the sheet is conveyed in the single-side mode and the reverse mode, second-side control is carried out (Step 11). The second-side control is the same control as the first-side control (Steps 2 to 8) in the first printer main body 1001A for the reciprocation position and the exposure position determined already in Step 1. The skew feeding and the registration correction of the sheet are carried out by the second skew feeding and registration correcting portion 1′.

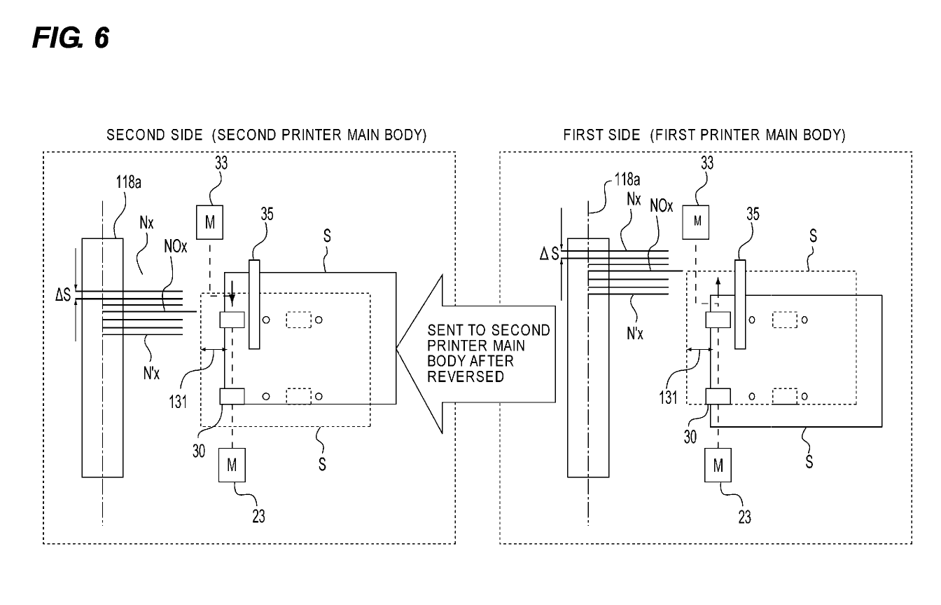

In Step 1, as the first-side control of the first printer main body 1001A, reciprocation positions Nx to N′x on opposite sides of a central reciprocation position N0X on the back side of the apparatus with respect to a sheet conveying standard position of the sheet fed from the sheet feeding apparatus 1002 are set as illustrated in FIG. 6. In the second-side control of the second printer main body 1001B, reciprocation positions Ny to N′y on opposite sides of a central reciprocation position N0y on the front side of the apparatus with respect to the sheet conveying standard position of the sheet are set. In the embodiment, the positions on the opposite sides of the central reciprocation position N0y which is substantially equal to the conveying standard position of the sheet fed from the sheet feeding apparatus 1002 are set.

If the sheet processing apparatus is provided to the second printer main body 1001B and if a widely displaced sheet is discharged to the sheet processing apparatus, the sheet may not be moved to a position where the sheet can be aligned by the sheet processing portion before the sheet reaches the sheet processing portion.

In this case, an alignment failure and a conveyance failure such as a jam are likely to occur, which affects processing of the sheet. However, by setting the positions on the opposite sides of the central reciprocation position N0y which is substantially equal to the conveying standard position of the sheet as the reciprocation positions, it is possible to prevent occurrence of the alignment failure and the conveyance failure such as the jam.

In the embodiment, to correct the side end position of the sheet by the first skew feeding and registration correcting portion 1 of the first printer main body 1001A, the sheet is moved in stages in a direction from the front side toward the back side which is one direction in the width direction. To correct the side end position of the sheet by the second skew feeding and registration correcting portion 1′ of the second printer main body 1001B, the sheet is moved in stages in an opposite direction to the one direction, i.e., in a direction from the back side toward the front side.

In other words, the sheet is always moved in the same direction by the pairs of registration rollers forming the lateral registration mechanism. For example, in the first skew feeding and registration correcting portion 1, the sheet is successively moved in stages from N′x (standard position) on the front side to Nx (predetermined position) on the back side in the width direction. After the sheet reaches Nx, it is moved again from N′x to Nx in stages. On the other hand, in the second skew feeding and registration correcting portion 1′, the sheet is moved successively in stages from Nx (standard position) on the back side to N′x (predetermined position) on the front side in the width direction. After the sheet reaches N′x, it is moved again from Nx to N′x in stages. By always moving the sheet in the same direction by the pairs of registration rollers 30 in this manner, i.e., by not changing the moving direction of the sheet, it is possible to suppress variation in lateral registration correction control.

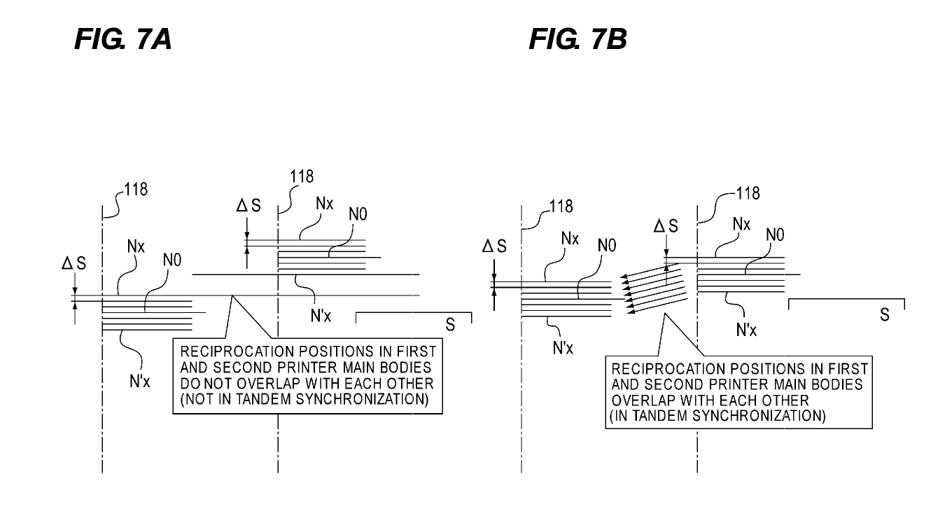

Furthermore, in the embodiment, as illustrated in FIGS. 7A and 7B, a moving range of the sheet in correction by the first skew feeding and registration correcting portion 1 and a moving range of the sheet in correction by the second skew feeding and registration correcting portion 1′ are different. In other words, a reciprocation target position which is a first correcting range in the width direction of the first side and a reciprocation target position which is a second correcting range of the second side are displaced from each other.

The reciprocation position is different between cases in which the first and second printer main bodies 1001A and 1001B are in synchronization and not in synchronization. FIG. 7A illustrates a relationship between the reciprocation positions when the first and second printer main bodies 1001A and 1001B are not in synchronization, i.e., when the first printer main body 1001A and the second printer main body 1001B correct the side end position of the sheet independently of each other.

Here, if the first and second printer main bodies 1001A, 1001B are not in synchronization, the CPU 120B of the second printer main body 1001B does not know the amount of correction of the side end position of the sheet in the first printer main body 1001A. Therefore, the reciprocation positions Nx to N′x of the first side are set on the back side so that the sheet which has been moved to the farthest back side in the first printer main body 1001A can be moved to the front side of the apparatus with respect to the sheet conveying standard position in the second skew feeding and registration correcting portion 1′. In the embodiment, the reciprocation positions Nx to N′x of the first side are set so as not to overlap with the sheet conveying standard position. The reciprocation positions Ny to N′y of the second side are set on the front side so as not to overlap with the reciprocation positions Nx to N′x of the first side.

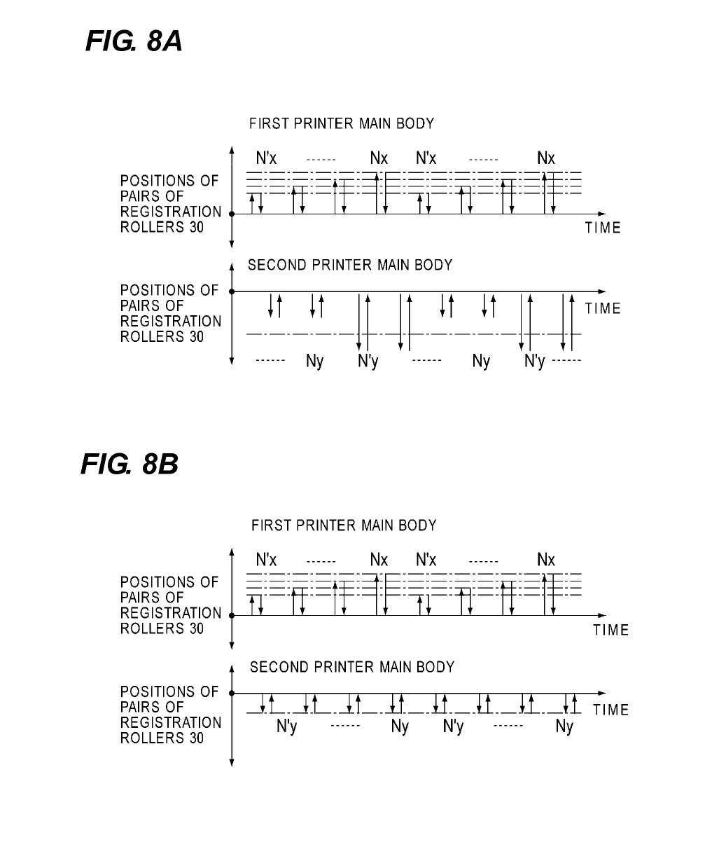

With this structure, the sheet is conveyed alternately to the first printer main body 1001A so that the image is formed on the first side and to the second printer main body 1001B so that the image is formed on the second side. Forming of the images on both sides is as illustrated in FIG. 8A. In lateral registration correction control of the first side by the first skew feeding and registration correcting portion 1, the pairs of registration rollers 30 correct the side end position of the sheet by always moving successively from the front side toward the back side from the sheet conveying standard position C and then return from the back side toward the front side. In lateral registration correction control of the second side by the second skew feeding and registration correcting portion 1′, the pairs of registration rollers 30 correct the side end position of the sheet by always moving successively from the back side toward the front side and then return from the front side toward the back side.

In this manner, by setting the reciprocation positions Nx to N′x (the moving range of the sheet) of the first side on the back side and disposing the reciprocation positions Ny to N′y (the moving range of the sheet) of the second side on the front side, the pairs of registration rollers 30 can carry out the lateral registration correction control in the same direction every time.

FIG. 7B illustrates a relationship between the reciprocation positions when the first and second printer main bodies 1001A and 1001B are in synchronization, i.e., when the first printer main body 1001A and the second printer main body 1001B operate in synchronization with each other to correct the side end position of the sheet. In this case, the CPU 120A of the first printer main body 1001A informs the CPU 120B of the second printer main body 1001B of the correction amount of the side end position of the sheet in the first printer main body 1001A. In this way, the CPU 120B of the second printer main body 1001B knows the correction amount of the side end position of the sheet in the first printer main body 1001A and therefore carries out correction of the side end position according to the correction amount of the side end position of the sheet in the first printer main body 1001A. As a result, in contrast to FIG. 7A, the reciprocation positions Ny to N′y of the second side can be disposed to partially overlap with the reciprocation positions Nx to N′x of the first side.

With this structure, as illustrated in FIG. 8B, it is possible to synchronize the reciprocation position of the second side with the latest reciprocation position of the first side in the first printer main body 1001A in an order of image forming in the second printer main body 1001B. In this way, movements of the pairs of registration rollers 30 are constant every time and the movement amounts of the pairs of registration rollers 30 are small in the lateral registration correction control of the second side and therefore variation in the lateral registration correction control of the second side can be suppressed and precision of the lateral registration correction can be increased.

As described above, in the embodiment, the sheet is moved from the front side to the back side in the correction by the first skew feeding and registration correcting portion 1 and the sheet is moved from the back side to the front side in the correction by the second skew feeding and registration correcting portion 1′. In other words, the sheet is moved in the opposite direction in correcting the side end position of the sheet by the second skew feeding and registration correcting portion 1′ with respect to the direction in correcting the side end position of the sheet by the first skew feeding and registration correcting portion 1. In this way, it is possible to increase the life of the fixing roller without causing increase in size of the apparatus and image displacement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-215927, filed Sep. 27, 2010, which is hereby incorporated by reference herein in its entirety.

What is claimed is:

1. An image forming apparatus including a first image forming portion which forms an image on a sheet and a second image forming portion which is provided on a downstream of the first image forming portion in a sheet conveying direction, the apparatus comprising:
a first correcting portion which is provided on an upstream of the first image forming portion in the sheet conveying direction, successively moves the sheet, which has been conveyed to the first image forming portion, from a standard position to a predetermined position in stages in a width direction orthogonal to the sheet conveying direction, and moves the sheet, which has reached the predetermined position, from the standard position to the predetermined position again in stages to correct a side end position of the sheet in the width direction;
a second correcting portion which is provided between the first image forming portion and the second image forming portion, successively moves the sheet, on which an image has been formed by the first image forming portion, from a standard position to a predetermined position in stages in the width direction, and moves the sheet, which has reached the predetermined position, from the standard position to the predetermined position again in stages to correct the side end position of the sheet in the width direction; and
a controlling portion which controls the first correcting portion and the second correcting portion,
wherein the controlling portion controls the first correcting portion and the second correcting portion so as to move the sheet in stages in one direction in the width direction in correcting the side end position of the sheet by the first correcting portion and to move the sheet in stages in an opposite direction to the moving direction of the sheet by the first correcting portion in correcting the side end position of the sheet by the second correcting portion.

2. An image forming apparatus according to claim 1, wherein a moving range of the sheet in correcting the side end position of the sheet by the first correcting portion and a moving range of the sheet in correcting the side end position of the sheet by the second correcting portion do not overlap with each other in the width direction.

3. An image forming apparatus according to claim 1, wherein, in correcting the side end position of the sheet by the second correcting portion, the control portion moves the sheet in stages according to a movement amount of the sheet in the width direction in correcting the side end position of the sheet by the first correcting portion.
